(19) United States
(12) Patent Application Publication
(10) Pub. No.: US 2025/0188755 A1
(43) Pub. Date: Jun. 12, 2025

(54) Method for 3D Printing Architectural Components

(71) Applicant: Technion Research & Development Foundation Limited, Haifa (IL)

(72) Inventors: Aaron Sprecher, Tel Aviv (IL); Arnon Bentur, Tel Aviv (IL); Ofer Asaf, Haifa (IL); Pavel Larianovsky, Haifa (IL); Oded Amir, Haifa (IL); Eliad Michli, Tel Aviv (IL)

(73) Assignee: Technion Research & Development Foundation Limited, Haifa (IL)

(21) Appl. No.: 18/970,832

(22) Filed: Dec. 5, 2024

Related U.S. Application Data
(60) Provisional application No. 63/607,251, filed on Dec. 7, 2023.
(60) Provisional application No. 63/607,262, filed on Dec. 7, 2023.

(51) Int. Cl. E04G 21/02; B33Y 10/00; B33Y 50/00; B33Y 70/00; B33Y 80/00

(52) U.S. Cl. CPC E04G 21/02; B33Y 50/00; B33Y 10/00; B33Y 70/00; B33Y 80/00

(57) ABSTRACT

A method for providing an architectural component, the method includes (i) receiving, by a computerized system, a request to design a manufacturing process of an architectural component; (ii) determining, by the computerized process, the manufacturing process by applying an interactive design process that takes into account interactions between (a) material composition parameters, (b) architectural design parameters, and (c) manufacturing parameters; wherein the manufacturing process is an additive three dimensional printing process; and (iii) responding to the designed manufacturing process.

### CROSS REFERENCE

This application claims priority from each one of U.S. provisional patent application Ser. No. 63/607,251 and U.S. provisional patent application Ser. No. 63/607,262, both having a filing date of Dec. 7, 2023—each being incorporated herein in their entirety.

### BACKGROUND

In the realm of architectural construction, the advent of 3D printing technology has opened up new frontiers in design and manufacturing. Traditional construction methods often involve labor-intensive processes with significant material wastage and design constraints. Although recent advancements in 3D printing have begun to address these issues, current technologies still face significant challenges, particularly when it comes to printing large-scale, multifunctional architectural components.

Existing 3D printing methods typically rely on standard material compositions that may not be ideally suited for complex architectural designs or multifunctional applications. These methods often require separate stages for material preparation, design conceptualization, and the actual printing process. This disjointed approach can lead to inefficiencies and limitations in the final product, such as compromised structural integrity, limited design complexity, and inadequate functional integration.

Moreover, most current 3D printing techniques for architectural components do not fully exploit the potential for customization and often require additional curing or post-processing steps, which can be time-consuming and resource intensive. There is also a growing concern about the environmental impact of construction materials and methods, with a need for more sustainable practices.

### BRIEF DESCRIPTION OF THE DRAWINGS

FIG. 1A illustrates an example of a method;

FIG. 1B illustrates an example of Optimal material window based on rigidity and flowability;

FIG. 2 illustrates an example of an optimal grading for 3D printing;

FIG. 3 illustrates an example of Rheological properties of a 3D printable mixture for a reactive and non reactive systems;

FIG. 4 illustrates an example of Chemical admixtures that can be introduced to the mix to increase static yield build-up rate, without affecting the dynamic yield;

FIG. 5 illustrates an example of;

FIG. 6 illustrates an example of Relations between the dynamic modulus of elasticity and the static yield strength;

FIG. 7 illustrates an example of Control over the material strength by tuning w/c ratio;

FIG. 8-Controlling the ductility of the mix by introducing high modulus fibers (the % values are volume %);

FIG. 9 illustrates an example of Control over the material and manufacturing parameters for ensuring layer stability;

FIG. 10 illustrates an example of Results of structural optimization considering stability of the fresh layers;

FIG. 11 illustrates an example of Designated cavities for reinforcement;

FIG. 12 illustrates an example of Utilities incorporation;

FIG. 13 illustrates an example of Macro and Micro patterns for texture finish, including non-planar printing utilizing 3D printing capabilities;

FIG. 14 illustrates an example of Thermal performance optimization of the element, cavities for structural support and utilities, as well as architectural finish of high durability performance (low permeability);

FIG. 15 illustrates an example of Various cross-section can be introduced to the design for optimizing thermal performance;

FIG. 16 illustrates an example of a Multifunction 3D printed wall;

FIG. 17 illustrates an example of Particle grading of the raw materials;

FIG. 18 illustrates an example of Particle size distribution of the clay and microsilica;

FIG. 19 illustrates an example of Loading test designed to evaluate the rigidity of the material in the green state;

FIG. 20 illustrates an example of Specimens for mechanical testing of the hardened material: box printed specimens from which specimens were cut for loading test;

FIG. 21 illustrates an example of Loading in flexure of specimens cut from the printed box in FIG. 20, in direction which is sensitive to the bonding between printed layers;

FIG. 22 illustrates an example of a robotic cell setup for 3D printing clayey soils, featuring an industrial robotic arm, mortar pump, and concrete vibrator;

FIG. 23 illustrates an example of shear stress vs. shear strain obtained in a static rheological test of a cementitious system, immediately after mixing and after 15 minutes resting time;

FIG. 24 illustrates an example of Results of statistical analysis of the performance parameters determined for clay mix system with varied composition, over a range of water/clay and sand/clay ratios and clay content in the mix;

FIG. 25 illustrates an example of relations between basic rheological and engineering parameters which are statistically significant: (a) Relation between flow rate through the printing nozzle head and the apparent coefficient of viscosity for clay systems, and (b) Relation between the rigidity of the green material and the static shear yield strength;

FIG. 26 illustrates an example of Controlled test to determine the yielding of the bottom layer during a printing test, showing sequential photographs before and after yield and collapse of the bottom layer;

FIG. 27 illustrates an example of Intersection of the calculated shear stress build-up at the bottom layer and the characteristic shear yield strength of the printed cementitious mix, for 180 mm diameter printed cylindrical column;

FIG. 28 illustrates an example of Intersection of the calculated shear stress build-up at the bottom layer and the characteristic shear yield strength of the printed white clay mix, for 180 mm diameter printed cylindrical column;

FIG. 29 illustrates an example of Typical cross section of printed layers of cementitious material;

FIG. 30 illustrates an example of Effect of nozzle height on the maximum, minimum and calculated width of the layers;

FIG. 31 illustrates an example of Effect of the velocity on the maximum, minimum and calculated width of the layers;

FIG. 32 illustrates an example of Effect of nozzle height on the flexural strength values of printed samples and standard ones;

FIG. 33 illustrates an example of Effect of nozzle velocity on the flexural strength values of printed samples;

FIG. 34 illustrates an example of Geometries of the printed blocks;

FIG. 35 illustrates an example of Compressive strength-unit weight curves of printed blocks, compared with a conventional one;

FIG. 36 illustrates an example of Specific strength as a function of wall thickness for printed and conventional blocks;

FIG. 37 illustrates an example of The printed construction components, wall (a) and beam (b);

FIG. 38 illustrates an example of Design of printing of construction components, stress loading curve at bottom layer and build-up of the static yield strength of the cementitious mix applied in the printing, (a) wall element, (b) beam element;

FIG. 39 illustrates an example of design concepts for stability, showing intersection of loading curves and the static shear yield strength curve and conditions required to avoid it and prevent failure, (dashed lines) with the static shear yield strength curve;

FIG. 40 illustrates an example of design concepts based on adjustment of material behavior (accelerating the build-up of the static shear yield strength) and control of printing speed;

### DETAILED DESCRIPTION OF THE DRAWINGS

Additive manufacturing is making inroads into the construction industry, which shows up in applications of 3D printing of components to be assembled on-site and the development of methods to enable 3D printing of full-scale structures on site, such as Contour Crafting and Gantry based technologies. To be effective in the construction industry, where large components need to be produced, the printing is unlikely to be based on technologies requiring the incorporation of highly intensive energy (e.g., heat, laser beams, electron beams) in the printing head, which is common in other industries. It will rather be based on materials printed in layers that develop sufficient green strength and then self-cure to obtain the hardened material's required mechanical and physical properties.

A wide range of granular materials has been considered for 3D printing, starting from relatively inert materials such as low-cost clay soils and wastes that can be activated up to normal and specially formulated cementitious binders. The use of such materials depends on their local availability and the structures' purpose, whether for low-cost or emergency shelters based on small unit construction, large-scale and geometrically complex structures, and buildings with higher levels of reactive granular materials will be needed. This category can even be expanded into the construction on the Moon, where the locally available Regolith is a granular material that includes 10% or more of glassy material which can be potentially activated, by means such as alkalis, to result in geo-polymer cementing material.

Although the granular materials can be different in their mineralogical and physical structure, as well as in their activating and cementing mechanisms, many common features enable to develop some fundamental guidelines for their evaluation and use, and these could provide the generic basis for development and design of granular materials for 3D printing.

Intensive research is carried out using this range of granular materials, ranging from low-activity solids to reactive cementitious systems. The reported works focus usually on specific aspects of the printing process, looking into the technologies of printing (e.g. gantry, robotic arm, crafting), types of elements that can be printed and challenges involved, the properties of the materials, characterizing in various ways their flow properties, in particular rheology, as well as other characteristics including extrudability, workability, open time, buildability, bonding between layers, green strength, setting and strengthening and mature properties. To a large extent, each of these issues is dealt with on its own for a specific granular binder.

The insights provided in these studies are extremely important, yet there is a need to take another step forward and to provide a holistic approach to the whole printing process, integrating all aspects of the printing technology, including properties of materials and the type of structure or component that is being printed. This approach is required for optimization, adjusting for example the properties of the granular material to the component which is being printed as well as to the technology of printing, or alternatively, considering control of the printing parameters (e.g. positioning of the printing head, the speed of printing) and adjusting them to the materials properties to assure that there are no defects in the printed component. Design principles based on the fundamental properties of the material need to be achieved. These principles can enable the proper design of the whole process as well as formulating the composition of the granular material, taking advantages of local available raw materials and adjusting their properties by use of various admixture and additives. This approach implies that there is no necessity to resort to a single formulation of a granular material for 3D printing, and there is an option to design the material for printing, modifying it for various technologies of printing and the availability of local raw materials, an approach which is somewhat analogous for concrete mix design in the ready-mix industry.

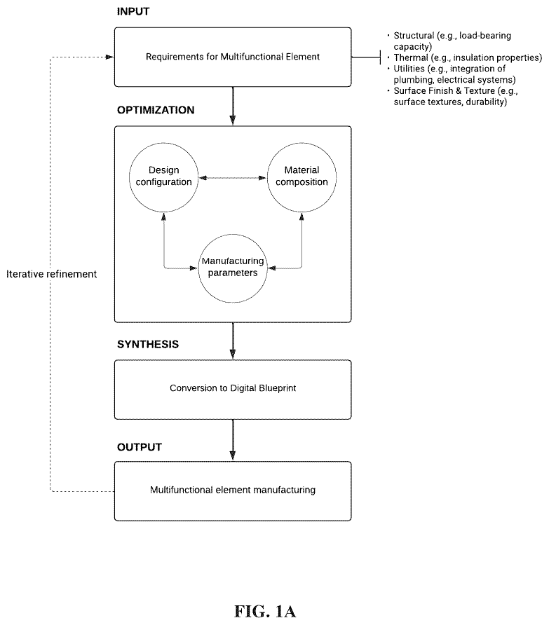

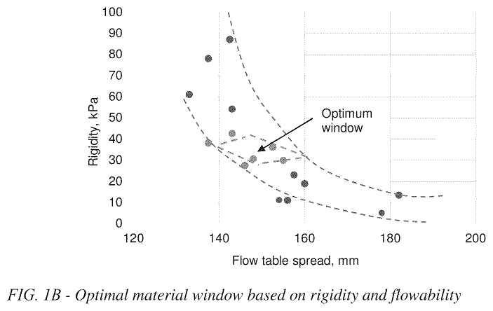

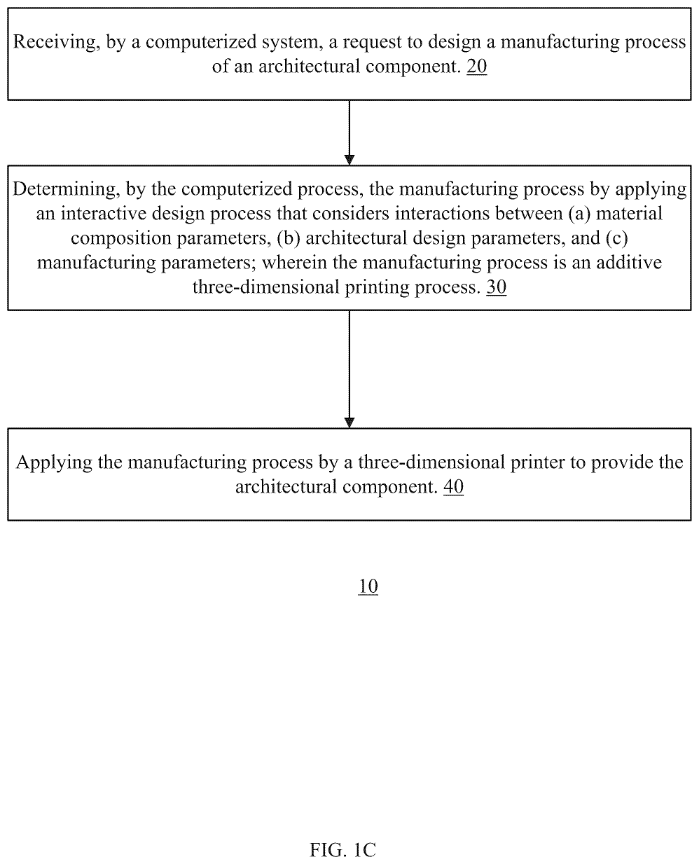

According to an embodiment, there is provided a method (see FIG. 1C) for providing an architectural component, the method includes:

Receiving (Step 20), by a computerized system, a request to design a manufacturing process of an architectural component.

Determining (step 30), by the computerized process, the manufacturing process by applying an interactive design process that considers interactions between (a) material composition parameters, (b) architectural design parameters, and (c) manufacturing parameters; wherein the manufacturing process is an additive three-dimensional printing process.

Applying (step 40) the manufacturing process by a three-dimensional printer to provide the architectural component.

An example of the method is illustrated in FIG. 1A that includes iterative process in which three building blocks (design configuration, material composition and manufacturing parameters) are evaluated and interact with each other.

Step (i) mentioned above is referred to as “input: requirements for multifunctional element”. Step (ii) mentioned above is referred to as (a) “optimization” and illustrates an iterative relationship between “design configuration”, “material composition” and “manufacturing parameters”, and (b) “synthesis: conversion to digital blueprint”. Step (iii) mentioned above is referred to as “output: multifunctional element manufacturing”.

According to an embodiment, the method includes storing manufacturing process information regarding the manufacturing process in a file that is access controlled, and applying an access control scheme for allowing access only to authorized three-dimensional printer while preventing authorized three-dimensional printers from accessing the file and applying the manufacturing process.

According to an embodiment, the step 30 includes determining a cementitious mix that is tailored for the additive three-dimensional printing process.

According to an embodiment, step 30 includes the determining of the cementitious mix by determining a composition of the cementitious mix by incorporating a variety of mineralogical additives/fillers and chemical admixtures along with cement and graded siliceous sand.

According to an embodiment, step 30 includes the determining of the cementitious mix by simulating different candidate compositions of the cementitious mix.

According to an embodiment, step 30 includes the determining of the cementitious mix by determining a window of optimization of properties of the cementitious mix.

According to an embodiment, step 30 includes selecting the cementitious mix based on particle size distributions of different candidate compositions of the cementitious mix within the window.

According to an embodiment, step 30 includes the determining of the cementitious mix by determining the rheological properties of the cementitious mix.

According to an embodiment, the rheological properties of the cementitious mix are evaluated (during step 30) based on manufacturing parameters related to the additive three-dimensional printing process.

According to an embodiment, step 30 includes the determining of the cementitious mix based on (a) required dynamic yield strength throughout the additive three-dimensional printing process, and (b) a required static yield strength rapidly increase once the cementitious mix is deposited as a layer during the additive three-dimensional printing process.

According to an embodiment, step 30 includes determining a static and dynamic yield strength of the cementitious mix.

According to an embodiment, step 30 includes modelling a stability, within a defined period of time in an absence of dedicated curing process, of a layer of the cementitious mix that was printed during the additive three-dimensional printing process.

According to an embodiment, step 30 includes maintaining a stress build-up on any layer of the cementitious mix of the architectural component is below a static yield strength of the layer.

According to an embodiment, step 30 is responsive to an inflection point of the cementitious mix.

According to an embodiment, at least one manufacturing parameter is determined based on the inflection point.

According to an embodiment, the at least one manufacturing parameter is a printing rate.

According to an embodiment, step 30 includes iteratively adjusting the printing parameters and material composition parameters of the cementitious mix over time.

According to an embodiment, the method includes determining one or more architectural design parameters following a finding of one or more cementitious mix candidates that once printed provide a layer of at least a required stability.

According to an embodiment, step 30 includes determining one or more architectural design parameters, wherein the determining one or more architectural design parameters includes defining a shape and an internal structure of the architectural component.

According to an embodiment, the defining of the shape and of the internal structure ensures mechanical stability of the architectural component.

According to an embodiment, the defining of the shape and of the internal structure further minimizes a usage of a cementitious mix during the additive three-dimensional printing process.

According to an embodiment, step 30 is responsive to requested multiple functionalities of the architectural component.

According to an embodiment, step 30 is responsive to a passage of utility conduits through the architectural component.

According to an embodiment, step 30 is responsive to a thermal performance of the architectural component.

According to an embodiment, step 30 includes optimizing the interactions between (a), (b) and (c).

According to an embodiment, step 30 includes adjusting one or more rheological properties of a cementitious mix to meet manufacturing parameters.

According to an embodiment, the manufacturing parameters includes at least one of printing speed and nozzle movement.

According to an embodiment, the rheological properties includes a transition of a cementitious mix from a fluid state to a solid state.

According to an embodiment, the manufacturing parameters includes overhang angles and overlap between layers of the cementitious mix.

### Mix Design for 3D Printing (Material Composition)

This invention introduces a comprehensive method for determining a cementitious mix, specifically tailored for 3D printing complex shaped multifunctional architectural and structural building components. The method involves a nuanced control of the composition by incorporating a variety of mineralogical additives/fillers and chemical admixtures along with cement and graded siliceous sand.

### Objective of the Mix Design

The primary aim of the mix design method is to produce mixes with specific properties that are crucial for the printing stage. These properties primarily include optimal flow and thixotropic behaviour to facilitate the printing of full-sized elements and achieve complex architectural finishes without the need for special curing methods like heat.

### Methodology of Mix Design (Material Composition)

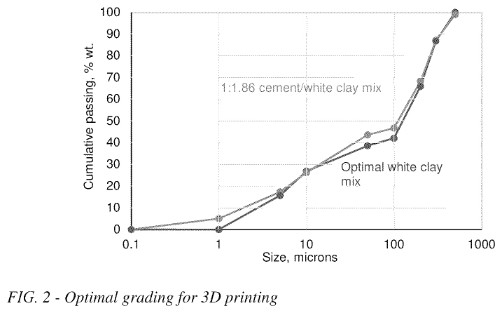

Experimental Simulation: Experimental simulation of a reactive cementitious mix using a non-reactive granular mix composed primarily of high kaolin clay (>70%) mixed with sand. This simulation is aimed at determining a particle size distribution composition that provides an optimal balance between flow properties (measured by ASTM flow table) and stability (assessed through rigidity in load tests). The results present a window of optimization, which is crucial for the subsequent design stages (FIG. 2). (material composition)

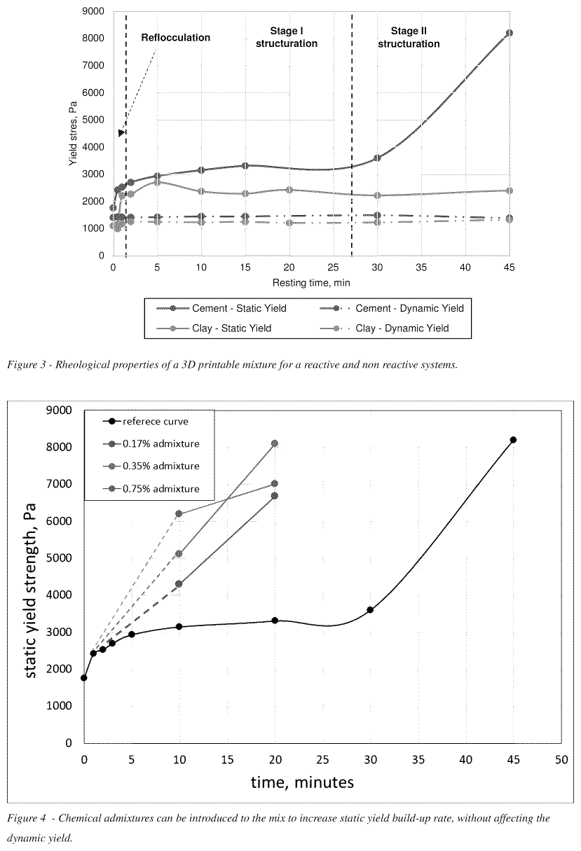

Optimization of Composition: The compositions identified within the optimal window are then characterized by their particle size distribution. This characterization serves as a guide for the actual design of the cementitious mix, which follows this distribution by combining cement with sand and a range of mineral additives and fillers, such as microsilica, clays, and limestone filler (FIG. 3). The dry material is then mixed with water and a superplasticizer admixture to achieve a specific flow range in the ASTM flow table test. The cement content, along with the water and admixture content, is adjusted to provide a variety of water-to-cement (w/c) ratios, allowing control over the density and strength of the hardened mix. (material composition)

Rheological Property Control: An essential aspect of the mix design involves characterizing and controlling the rheological properties, particularly static and dynamic yield strengths (FIG. 4). These values can serve as inputs to modelling and design procedures of the printing process, to facilitate the flow from the pipes to the printing head and for the printing of the layers, as well as assuring build-up of rigidity immediately after depositing of a layer, to be able to support the layers built upon it, all of that without the need for external energy source such as heat. The goal is to maintain a low dynamic yield stress throughout the printing duration to facilitate flow, while ensuring that the static yield strength increases rapidly once the material is deposited as a layer. This rapid increase is at the core of the mix design to facilitate architectural freedom while ensuring good deposition and stability post-deposition. (material composition)

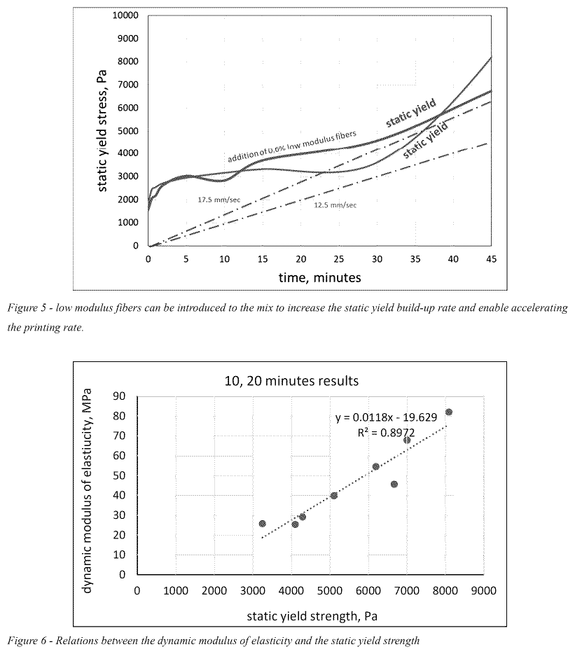

Chemical and Physical Means for Rheological Control: To control the rheological properties effectively over the printing stage (one hour or less), both chemical and physical means are employed. Chemical methods are used to accelerate the development of static yield while keeping dynamic yield low and constant (FIG. 5). Additionally, low modulus fibers can be used to further enhance these properties (FIG. 6). (material composition)

Ultrasonic Testing for Routine Evaluation: Given the complexity of rheological testing, additional methods have been developed for routine purposes, with ultrasonic testing being particularly useful. This involves establishing relationships between the dynamic modulus of elasticity and the static yield strength (FIG. 6). (material composition)

### Development of High-Performance Properties

High Strength and Durability: The mix is designed to achieve high compressive strength (more than 50 MPa) and low permeability, essential for durable and impermeable surface finishes. This is achieved by controlling the w/c ratio and the type of mineral additives and fillers (FIG. 8). (material composition)

Enhanced Ductility with High Modulus Fibers: To achieve high ductility, the mix incorporates a variety of high modulus fibers in the form of dispersed filaments (FIG. 9). These fibers are effectively dispersed into individual filaments using admixtures like viscofying agents. (material composition)

### Environmental Considerations in the Mix Design

An integral aspect of the mix design is its environmental consciousness. The system is tailored to accommodate the inclusion of sustainable materials, including by-products and recycled materials, in the mix design. These materials are usually fine-grained, making them well-suited for the additive manufacturing process employed in 3D printing. (material composition)

### Modelling of Layer Stability in the 3D Printing Process (Design Configuration)

Another aspect of the invention is the modelling of layer stability during the 3D printing process, particularly for the manufacturing of large architectural elements. This modelling is essential for enabling the printing of large components without the need for special curing techniques, such as heat application, and is primarily based on the careful analysis of the rheological properties of the cementitious mix.

### Rheological Properties and Stability

Focus on Static and Dynamic Yield Strengths: The modelling centres around the static and dynamic yield strengths of the mix. Understanding how these properties change, particularly in the first hour after mix preparation, is crucial in predicting and managing the behaviour of the material as it is deposited layer by layer. (design configuration)

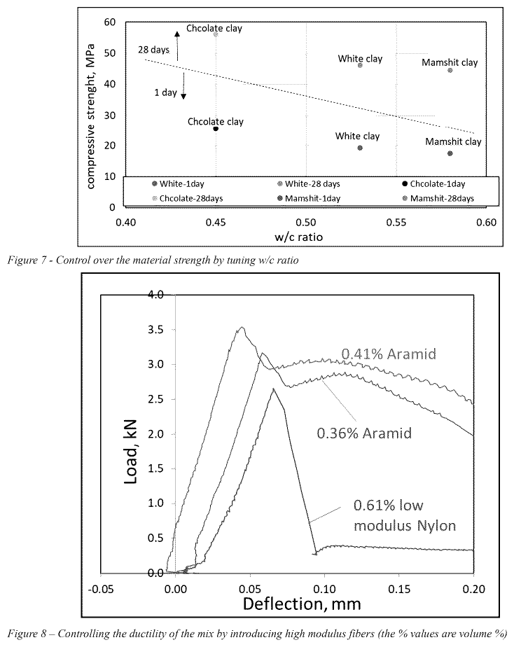

Management of Stress Build-Up: A key challenge addressed by the modelling is the management of stress build-up on the bottom layer during the printing process. It is essential that the stress imposed on each printed layer does not exceed its static yield strength to maintain structural integrity. This balance is achieved by ensuring that the printing stress curve remains below the strength curve, FIG. 10. This is an example of an interaction between design configuration and material composition

### Controlling the Printing Process

a. Inflection Point of Static Yield Curve:

The modelling considers the inflection point of the static yield curve as a critical factor in controlling the printing rates. By using chemical and physical means to adjust this inflection point, to occur at shorter time values, the method allows for increased printing rates without compromising the stability of the layers, FIG. 10.

b. Manufacturing Parameters

Integrated Design Adjustments: The method involves making design adjustments that consider both the printing parameters, such as the rate of build-up of layers, and the evolving properties of the mix over time. The approach is exemplified in figures and references that illustrate how these adjustments can optimize both the material properties and the printing process. This is an example of an interaction between design configuration and material composition, Interaction between design configuration and Manufacturing parameters, Interaction between material composition and Manufacturing parameters

### Practical Application

The application of these modelling concepts is outlined in FIG. 10, demonstrating how adjustments in the mix and printing parameters can be designed concurrently to ensure optimal stability and efficiency in the printing process.

### Computational Design for Optimal Performances (Design Configuration)

Following the establishment of layer stability, the invention leverages advanced computational tools to further refine the design and production of architectural elements. These tools serve as a critical component in the transition from theoretical modelling to practical, physical creation.

### Structural Design Optimization

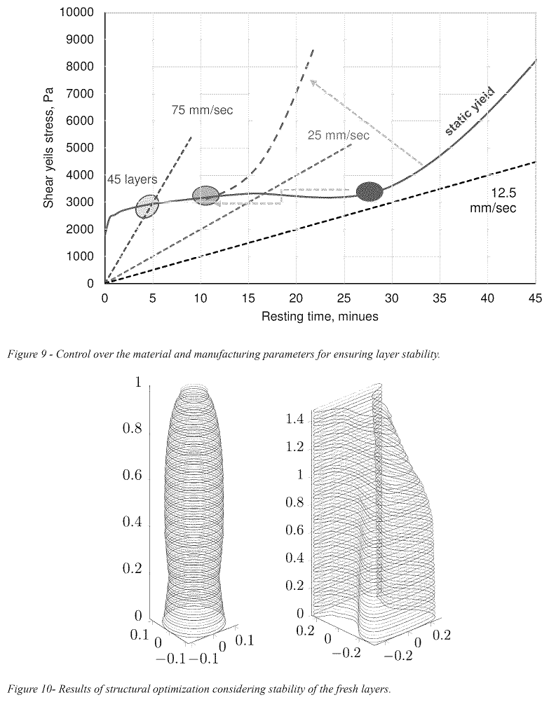

Utilizing an optimization algorithm, the design tool facilitates the creation of complex, multifunctional elements. The algorithm is designed to optimize the architectural component's shape and internal structure, ensuring mechanical stability, and reducing material usage (FIG. 11). It does so by controlling the size and configuration of internal support structures, like ribs, and by dictating the external contours to strategically allocate material in stress-prone regions. These include the insertion of designated places for reinforcing the element. (FIG. 12) (design configuration)

### Utilities Incorporation

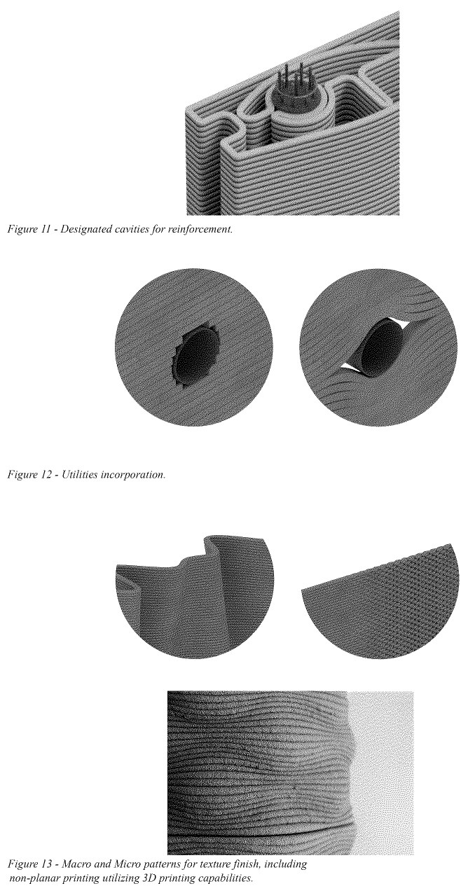

The design tool also ensures the incorporation of utility conduits within the structure of the printed elements in predesigned cavities. These integrated channels are strategically placed to facilitate the seamless installation of utility systems. (FIG. 13) (design configuration)

### Aesthetic Pattern

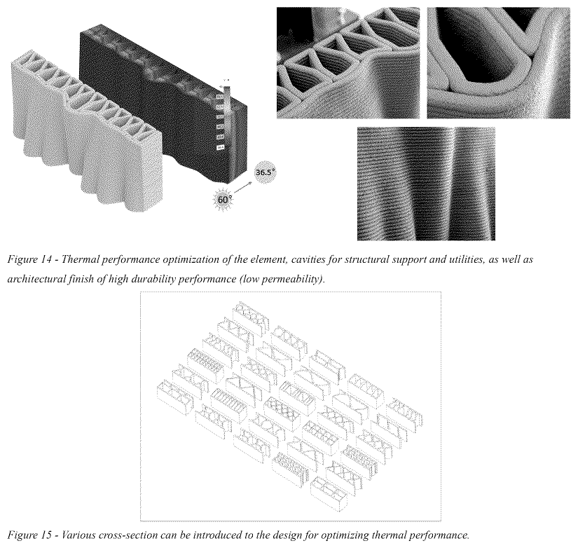

The design tool also introduces the ability to generate customized patterns to enhance the aesthetic appeal of the structure. This can be introduced both on the macro level (the entire element scale) and micro level (the layer scale). (FIG. 14) (design configuration)

### Thermal Performance Optimization

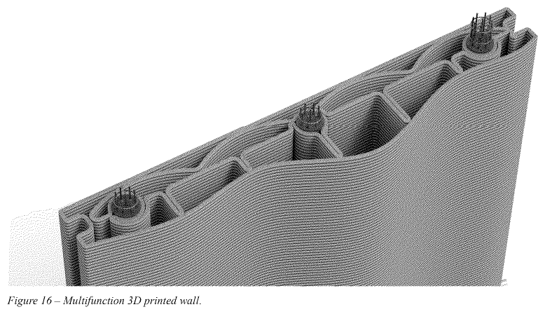

The algorithmic design considers thermal performance parameters, such as insulation needs and thermal mass distribution (FIGS. 15 and 16). By adjusting the design to include features like cavities and channels, the printed elements can provide enhanced thermal resistance, contributing to energy efficiency and occupant comfort in the built environment. This approach aligns with sustainable building practices by minimizing energy consumption for heating and cooling. (design configuration)

### Ensuring Multifunctionality Through Design

The computational platform also emphasizes the multifunctionality of the designs (Section 3). It accounts for various factors, such as thermal performance, by controlling the shape and volume of cavities within the printed components. These cavities not only contribute to the element's insulation properties but may also serve as conduits for utilities, such as water and electrical systems, or as ducts for air flow in HVAC systems. (design configuration)

### Unified Computational Platform

The computational platform serves as the central hub for optimizing the interaction between material properties and printing parameters. This ensures the material behaves in accordance with the intricately designed geometries and the requirements of modern architectural structures.

### Integrated Design and Manufacturing Process

The integration of the design tool with the mix design method forms a comprehensive system that encompasses the complete printing process. This system is adept at adjusting the rheological properties of the mix to meet the precise demands of the printing technology, such as print speed and nozzle movement. This integration is pivotal in enabling the creation of large-scale, structurally complex elements that are both functional and aesthetically pleasing. This is an example of an interaction between design configuration and Manufacturing parameters, Interaction between material composition and Manufacturing parameters.

### Precise Material Property Optimization

The platform's algorithms are capable of fine-tuning key material properties, such as dynamic and static yield strengths (Section 1), to cater to the specific needs of the printing process. This fine-tuning is essential for managing the behaviour of the material as it transitions from a fluid to a solid state, ensuring each layer is deposited with precision and maintains its stability throughout the entire printing process (Section 2). This is an example of an interaction between design configuration and material composition, Interaction between material composition and Manufacturing parameters.

### Manufacturing Alignment with Design

The platform ensures that each design is not only theoretically sound but also practical for manufacturing. It takes into consideration the manufacturing constraints, such as overhang angles and layer overlap, to guarantee that the designs can be realized using 3D printing technology without the need for extensive post-processing. This is an example of an interaction between design configuration and Manufacturing parameters, Interaction between material composition and Manufacturing parameters

The culmination of the computational design and optimization tools forms a holistic system that enhances the entire manufacturing process to create multifunctional construction elements in one go (FIGS. 15 and 16). This system ensures the manufacturability of complex designs using 3D printing technology and streamlines the printing parameters, resulting in a time-efficient and cost-effective solution for creating multifunctional architectural elements.

### Research Plan

The experimental program was carried out simultaneously at several levels with integration between them:
a. Raw materials and mix design, based on characterization of relatively passive and active materials, kaolin clay (labelled white clay) and a cementitious mix with type I Portland cement, kaolin clay and microsilica.
b. Properties of cement and clay mixes in the green state, basic physical parameters determined by rheological and loading tests, as well as engineering-standard type tests, mainly flow table tests.
c. Properties of cement mixes in the hardened state, to evaluate the strength of the printed layers and the bond between them, as well as comparison with standard tests of cast specimens.

Effect of printing technology parameters, position of the printing head above the printed surface, the velocity of the printing head and the pumping rate, to determine their influence on the geometry of the printed layers and the occurrence of defects

### Optimization:

Mix composition: Optimization of the mix composition for particular printing conditions by determining experimentally the optimal grading of the granular material, with the clay mixes (various clay: sand ratios and water content) serving as the model material.

Printing process: Optimization with regards to the printing process, by modeling the stability of the printed layers in the green state, based on the concepts developed by Kruger et al and developing design procedures to assure compatibility between materials properties to achieve successful printing and stability of different types of components

Materials consumption: Optimization to achieve equal performance with up to 50% reduction in materials consumption by demonstrating the concept for blocks, comparing printed blocks of various geometries with conventional commercial concrete block.

### Composition of Raw Materials

The two granular materials systems used were based on Type I Portland cement and kaolin clay. The mixes were mortars using quartz graded sand with maximum grain size of 2 mm. The cementitious matrix also contained mineralogical additives, kaolin clay, and microsilica, with addition of polycarboxylate superplasticizer.

The particle grading of the raw materials are presented and compared in FIG. 17. The differential and cumulative particle size distribution of the clay and microsilica is shown in

Table 1 illustrates an example of Mineralogical Composition of raw materials

Cement

| | | | | | | Calcium | | | |
|---|---|---|---|---|---|---|---|---|---|
| | | | | Calcium | C3A- | sulfate | C3A- | | Calcium |
| | C35- | C25- | C4AF- | carbonate- | Aluminate | hemihydrate- | Aluminate | | sulfate- |
| Phase | Alite | Belite | Ferrite | Calcite | cubic | Bassanite | orth | Aphthitalite | anhydrite |
| Weight % | 55.85 | 19.05 | 14.11 | 4.38 | 3.24 | 1.69 | 1.18 | 0.33\| | 0.17 |

Clay - White

| Phase | Kaolinite | Muscovite | Microcline | Quartz | Enstatite | Vermiculite |
|---|---|---|---|---|---|---|
| Weight % | 99.3 | 4.0 | 1.7 | 0.4 | 0.3 | 0.2 |

### Testing Green Material

Rheological test, using rotational rheometer (ICAR Rheometer) which was developed for testing of mortars and concretes. It was used in two modes, static to determine the static yield strength as well as shear modulus, and dynamic mode to determine the dynamic yield strength and apparent viscosity, by modeling the results in terms of the Bingham body.

Flow test, using the ASTM C 230 flow table test for mortars, where the properties are evaluated by means of the spread value of the mix, after 25 jolts.

Flow rate of the pump as a function of the rheological properties of the material, by activating the pump at various voltage inputs and determining at each the rate of flow by measuring the amount of material collected over a pre-determined time period.

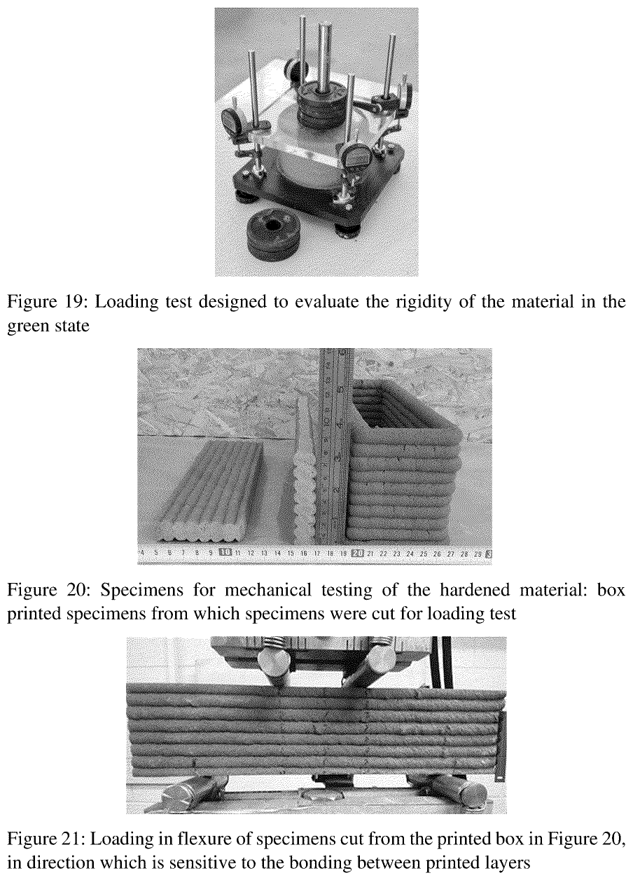

Rigidity test of the fresh, green mix, using the loading apparatus shown in FIG. 19. The green specimen was 100 mm in diameter and height. Load-deformation curves were obtained and the rigidity coefficients, defined as the initial slope of the curves were calculated. At this stage, the loading was manual, by placing dead weights as shown in the figure and measuring the deformation. A typical test took about 10 minutes and thus can be considered as a slow test, implying that the deformations measured include elastic as well as plastic. Load-deformation curves were linear at the early stages of loading and thus, the rigidity coefficients, defined as the slope of the curves were calculated. This is apparent rigidity, as the deformation measured included some plastic component. The test under such conditions was intended to be for comparison between different compositions and cannot be considered as one which is adequate for analysis of basic mechanical properties.

Unit weight of the green material was obtained by weighing specimens compacted in 1000 cm³ container.

### In-Situ Testing

In-situ testing was based on printing of cylindrical specimens, 180 mm in diameter, while continuously monitoring the height of the layers upon printing. The printing was carried out up to the collapse of the cylinder, recording the time to failure and the number of layers at failure. In some of the tests, the printing was accompanied by continuous photography (frames taken at 6 seconds time intervals) with special emphasize on the bottom layers, and afterwards image analyzed to determine the height of the layers and the change during the printing process, e.g., their compression. A set of cylinders was also printed to a stage before failure and after their hardening they were cut along their height exposing the cross area of the layers. The exposed cross-section was analyzed to characterize the interface between layers (characterization of the nature of bonding) as well as measuring the geometry of the layers (height and width) and their variations along the printed layers, from bottom to top.

### Testing of Hardened Material

The mechanical properties were characterized by cast samples according to the ISO test method for cement mortars as well as by testing printed samples using a special assembly described below.

The standard test was based on casting 40×40×160 mm beams, tested at 1 and 28 days for flexure (recording load-deflection) to determine flexural strength and load-deflection curves. Also, the halves of the broken beams, obtained after the flexural test, were used to determine compressive strength.

For the testing of printed materials, printed box shaped specimens were produced and after hardening samples were cut from the walls of the box (FIG. 20). These cut samples were tested in flexure at 28 days, in two directions, at a span of 210 mm: samples placed vertically, (FIG. 21) where the flexural test is sensitive to the bond between layers (it is where delamination may take place) and horizontally, where the flexural strength is sensitive to the bulk printed material strength and not to the bond. Load-deflection curves were recorded, and the mode of failure was followed by photography during the loading, to determine whether it was by a crack crossing the layers or by delamination.

### Printing Setup

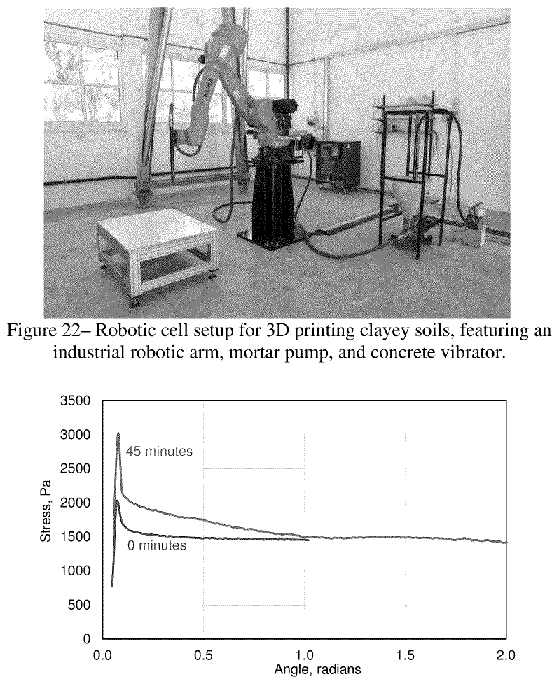

The robotic setup used for this research is shown in FIG. 22. The setup includes a KUKA KR50R2100 industrial robotic arm, featuring a payload of 50 kg and a radial range of 2100 mm. The printhead used for printing comprised a 450 mm long metal rod, which was mounted perpendicularly to the robot flange. The nozzle used in the printhead was 3D printed from PET-G and featured a cross-section of 12 mm diameter.

The mortar pump used for the printing process was MAI 2PUMP-PICTOR, with a 24 L worm pump, featuring a flow rate of 1.5-8.5 L/min. A concrete vibrator was used to promote the mixture flow from the hopper to the worm pump. A DC power supply was connected to the pump to control the flow rate by altering the supplied voltage. A 10 meter high-pressure hose was used for delivering the mixture from the pump to the printhead mounted on top of the robotic arm.

### Results

### Typical Mix Compositions for Printing and Printing

Typical mix compositions of clay-based and cement-based mixes are presented in Table 2 as weights of components per m³, including the water content required for obtaining adequate rheological properties. The grading of the solids are presented in FIG. 2. These are compositions which were derived after several trials and were found to be adequate for the printing with the procedure available, namely nozzle print head diameter of 12 mm, nozzle height ranging from 6 to 12 mm, velocity of print head in the range of 0.105 to 0.155 meter/second and flow rate in the range of 0.5 to 4 liter/minute.

The effect of changing the mix composition was studied mainly in the clay mix, by changing the ratios of the clay/sand ratio, the clay content, and the water/clay ratio.

TABLE 2
illustrates an example of Typical mix compositions
(mixes which provide adequate properties for printing)

| | Cement-white | White |
|---|---|---|
| | clay-microsilica- | clay- |
| Component | sand | sand |
| Cement, CEM I, kg | 459.3 | 0 |
| White clay (kaolin), kg | 98.5 | 489.4 |
| Microsilica, kg | 98.5 | 0 |
| Sand, kg | 1221.3 | 0 |
| Water, kg | 238.6 | 324.0 |
| Polycarboxylate | 13.2 | 0 |
| admixture (HTC 698), kg | | |
| Unit weight, kg/m³ | 2129.4 | 2037.0 |

### Rheological Behavior

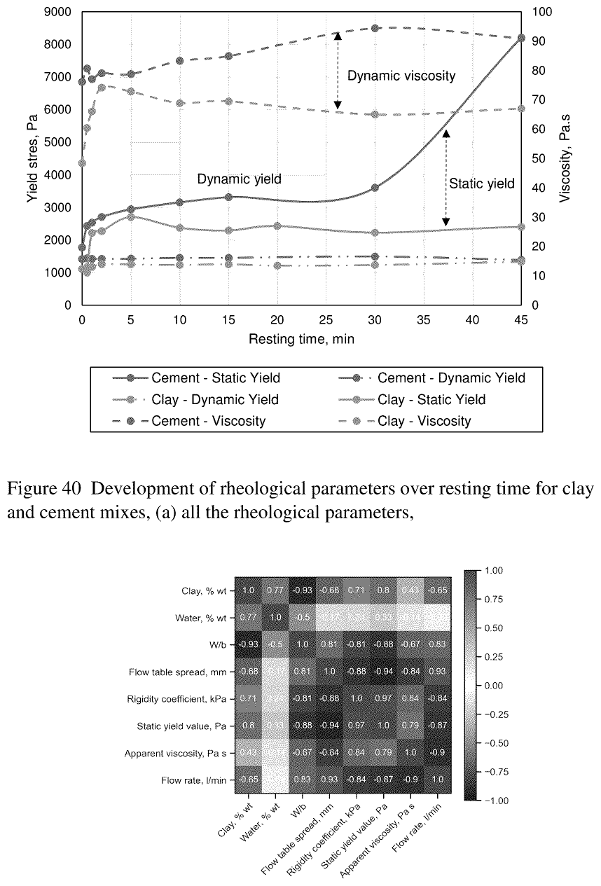

The analysis of the rheological tests for the purpose of 3D printing followed the concepts outlined by [Kruger et al, 2019, 2020] and [Roussel et al, 2012, 2018]. The rheological measurements were taken at time intervals, where in-between the material was kept stationary at the rheometer. During this resting time, there is build-up of internal bonding between the particles. To generate flow when activating the rheometer, at a low revolution rate, an initial shear stress is needed to be applied, which is larger than the stress required to keep the rotation going thereafter, after the material starts flowing, as demonstrated in FIG. 23.

The initial stress required to get the rheometer in motion is defined as the static shear yield strength. Afterwards the measurements continue in a dynamic mode of changing rotation rate (which is translated into shear strain rate units), obtaining a curve of shear stress against shear strain rate (or rotation rate), which takes a linear form which can be described by the Bingham model, and thus characterized by two parameters, dynamic shear yield stress and apparent coefficient of viscosity.

Typical results of the rheological parameters as a function of resting time are shown in FIGS. 3 and 3A, for the optimum clay and cementitious mixes in Table 2, representing two extreme granular systems, relatively passive and active. The time scale represents the resting time between consecutive measurements, up to 45 minutes. The cumulative time from the end of mixing is obviously larger and amounts to 100 minutes. The shape of the static shear yield strength followed the description provided by [Kruger et al, 2019, 2020] and [Russell et al 2012, 2018], addressing the thixotropy of cementitious systems, and accounting for the build-up of the static yield in terms of two processes, reflocculation and structuration (FIG. 3). In the current study two stages of the structuration test could be identified whereas Kruger et al reported only one stage.

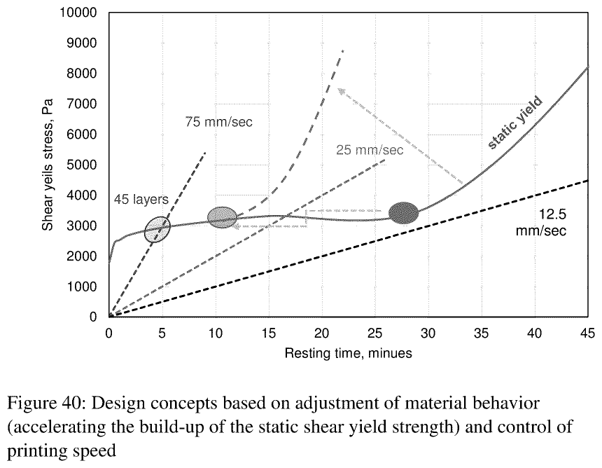

FIG. 40 illustrates a development of rheological parameters over resting time for clay and cement mixes for all the rheological parameters,

The trends in FIG. 40 indicate that the dynamic parameters, dynamic shear yield strength and apparent viscosity coefficient, are similar for the two systems, cement and clay, and they seem to be roughly constant over resting time of up to 45 minutes. In both systems the static shear yield stress is larger than the dynamic one.

The major difference between the two systems is in the static shear yield strength, FIG. 3. In the re-flocculation stage, the rise in the static shear yield stress is due to physical effect of consolidation, which is similar in the two systems, perhaps because of the overall similarity in the particle size distribution (FIG. 2). Thereafter, in the structuration stages, additional increase in the static shear yield strength is likely to be dependent on formation of stronger bonds, and this can take place in the cementitious system but not in the clay one. At this stage, even small production of hydration products in the cementitious system can have a significant impact on the static shear yield strength, where the stress levels are relatively small in the case of the material which is in its green stage.

The increase in the static shear yield strength over the dynamic one is a manifestation of the thixotropy of the system, which can be expressed in terms of the difference between the two yield values. In the re-flocculation stage the thixotropy is practically identical for the cement and clay systems, but from there on it develops quite significantly in the cementitous system while it remains constant in the clay one.

Ideally, for 3D printing, one would like to have a granular system where the dynamic yield strength and apparent viscosity are small and remain small as long as possible, since they affect the rate of flow in the pump and printing head. On the other hand, the stability of the green printed layers depends on the build-up of the static shear yield strength, and one would like this build up will be as quick and significant as possible, i.e., a strong thixotropic effect. This behavior takes place in the cementitious system but not in the clay. In the design of optimal granular material for 3D printing, the object would be to accelerate the thixotropic build-up (i.e., higher static shear yield strength) without increase in the dynamic rheological parameter, dynamic shear yield and apparent coefficient of viscosity. The means for that would be chemical admixtures or modifications of the binder in the case of the cementitious system, and activation of the clay by means such as incorporation of cement, lime, and biopolymers.

### Engineering Performance Values and Rheological Parameters of Granular Mixes

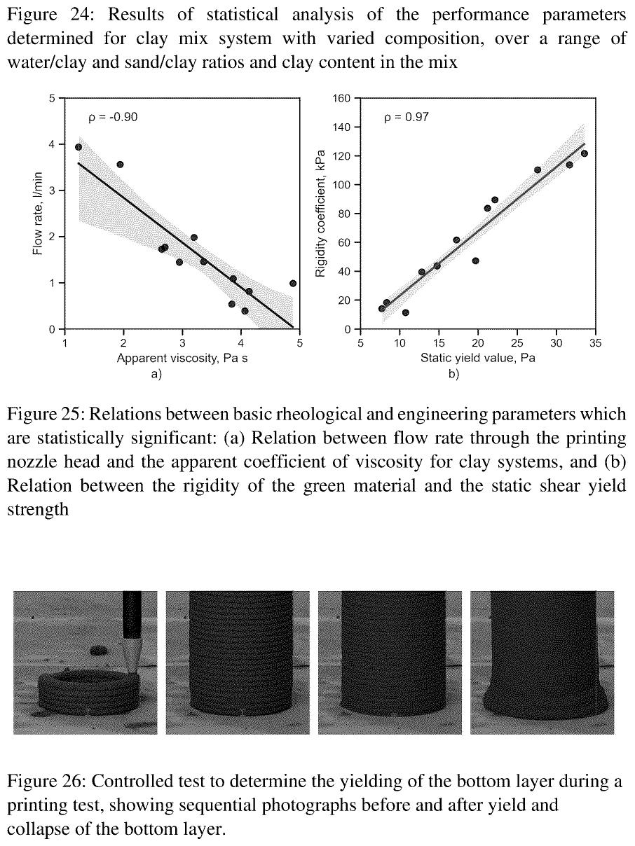

As discussed in the previous section, the static yield strength is relevant to the stability of the printed layers in the green state while the apparent viscosity and dynamic yield strength are of significance for controlling the flow rate through the nozzle of the printing head. These rheological characteristics will be compared with performance parameters obtained by lab, engineering type tests. For that purpose, a series of tests was carried out with the clay mix system, changing its composition (ratio between the white-kaolin clay and sand, as well as the content of water) over a wide range and characterizing the effect of composition by a variety of tests: rheological tests, which provide fundamental physical parameters, performance tests which included flow table test, flow rate measurement through the printing nozzle and the rigidity of the material. Statistical analysis to determine the relations between the various parameters was carried out, and their significance is presented in FIG. 24. Significant linear relations between the flow rate and apparent viscosity and between rigidity and static yield strength were found, FIG. 25.

### Design Principles

### Design Principles of the Granular Mix

The statistical analysis to resolve relations between the rheological and engineering parameters presented in the previous section can serve as a basis for insights which can be leveraged for optimal mix design (a) the rigidity correlated with static yield strength (0.97 correlation coefficient), and (b) the flow rate through the nozzle correlated well with the flow table test (0.93 correlation coefficient).

The analysis above suggests that the overall performance of the mix could be assessed by considering at the same time two performance tests, the flow table test and the rigidity obtained in the load test, one providing indication for the ease of flow and the other for the stability of the printed layers in the green state.

The relations between these two parameters for the clay system studied here are presented in FIG. 1B, in which the systems which provided adequate performance for 3D printing are highlighted, indicating a “window” of optimal performance.

This approach of identifying a “window”, based on relatively simple laboratory performance tests, can be very useful in practice as a guideline for developing optimal mixes. Yet, it should be noted that a “window” of this kind represents a “fingerprint” which is relevant to a specific printing technology, such as printing nozzle and size of printed elements; for different printing technologies and construction components a specific “window” needs to be developed.

The grading curves of the solids which represent the optimal performance in FIG. 1B are shown in FIG. 2 for the clay granular mix composition. It was used as a basis for the design of the optimal cementitious mix, by incorporating in it white clay (essentially kaolin) and microsilica. It should be noted that the addition of microslica was intended also to obtain additional plasticity, which could be needed, since the grading curve might not be an absolute criteria for that characteristic, as the clay particles in the range of 1 to 5 microns provide plasticity due to their shape. Indeed, in terms of performance, namely combination of flow and rigidity, this composition provided optimal behavior, and it is the one shown in Table 2.

### Design Principles of the Printing Process and the Stability in the Green State

The design principles employed in the present section are based on concepts and quantifications developed by [Kruger et al 2019, 2020], addressing the thixotropic behavior of cementitious systems, with special emphasize on the build-up of the static yield shear strength which could be characterized by rheological tests, as well as calculation of the shear stresses developed in the printed layers.

The relations in FIG. 1B represent two characteristics which are of relevance to the design with regards to flow and stability of the deposited layer. The flow parameter could be directly related to the performance of the pump as seen by the linear correlation coefficient between the two, being 0.93 (FIG. 25a). The rigidity is representative of the stability of the deposited layers, but in order to resolve in a more physically significant way for the design for stability, a methodology was applied, following Kruger et al, based on the mechanics of the green printed layered structure. Several controlled experiments were carried out, in which the build-up of printed layers of the cementitious material was followed visually and by photography, to determine the stage at which the bottom layer is yielding due to the dead weight of layers accumulation over it, FIG. 26a.

The shear stress at the bottom layer, at which yielding occurred, can be calculated as follows [Kruger et al, 2019, 2020]: (1) τ=ρ·g·h·N₁/(2·F_{AR}), where: τ—shear stress, ρ—density of green material, N₁—number of layers, and F_{AR}—strength correction factor that accounts for confinement due to smaller aspect ratio

In the current tests the aspect ratio for the printed layers was 0.5 and the relevant F_{AR} was 1.4.

During the test, a photographic follow-up of the bottom printed layers took place from the initiation of printing, with frames taken every 6 seconds. The frames at the time of failure in the test, presented in FIG. 26, took place at about 5 minutes, and the photographs, just before failure, at yielding and failure, 6 seconds in sequence, are shown in the figure. The conditions of the test were nozzle diameter and height of 12.5 mm and 10 mm, respectively, print head velocity 75 mm/second, density of the printed cementitious mix 2100 kg/m³ and the characteristic rheological behavior determined in the rheometer test is shown in FIGS. 3 and 3A for the static shear yield strength. The layers height was about 10 mm. The object printed was a cylindrical column of 180 mm in diameter.

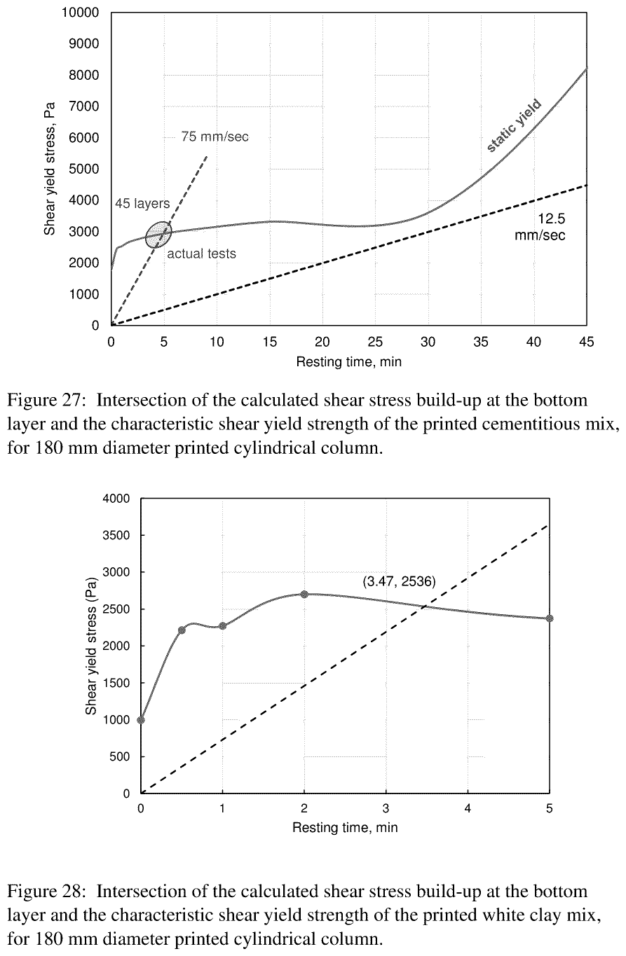

Several tests were run, with the failure occurring on the average at 5.17 minutes (17.2% coefficient of variation) with the number of layers at failure being 43.5 (16.9% coefficient of variation). Using equation (2), with the parameters of this test, enable to calculate the increase in the shear stress at the bottom layer with time, as layers after layers are being deposited on it, to determine a linear relation which intersects the characteristic yield shear strength curve of the material, FIG. 27. The intersection is at about 5 minutes, in agreement with the test results.

Another example, for the clay mix (clay: sand 1:1.86) is shown in FIG. 28, with the calculation resulting in a predicted failure at 3.5 minutes (210 seconds), with 6.8% coefficient of variation. This is close to the actual test results of 3.9 minutes, 12.5% higher than the predicted value. The printing conditions were nozzle diameter of 12.5 mm, printing velocity of 0.1 m/s and cylinder diameter 180 mm.

This suggests that the current procedure is a reasonable way to estimate the mechanical processes during printing and thus could serve as a basis for methodology for design. For example, in the current case of a printed component of cement mix of 180 mm diameter cylindrical column, the loading rate required to avoid failure during printing, should be reduced from the tested rate of 75 mm/second to 12.5 mm/second. This reduction will result in the loading curve passing below the inflection point (FIG. 27) which characterizes the onset of the second structuration stage (FIG. 3).

It should be noted that the calculation in these figures is “case specific”, i.e., for the 180 mm diameter column and the characteristic static shear yield strength curve of the material. For a larger diameter column, and the same velocity of printing, the shear stress load build-up curve would be much lower, and the intersection which denotes failure will occur later, or even not at all. A methodology of this kind could also provide guidelines for the material design, by making modifications in the mix design, to reduce the time at which the transition from stage I structuration to stage II would take place. Such considerations could provide the basis for optimizing the printing process by control of the printing parameters (e.g., velocity of the printing head) and the properties of the material, while taking into consideration the geometry of the printed component (e.g., diameter of the cylindrical column).

### Control of the Printing Process and the Geometry of the Printed Layers

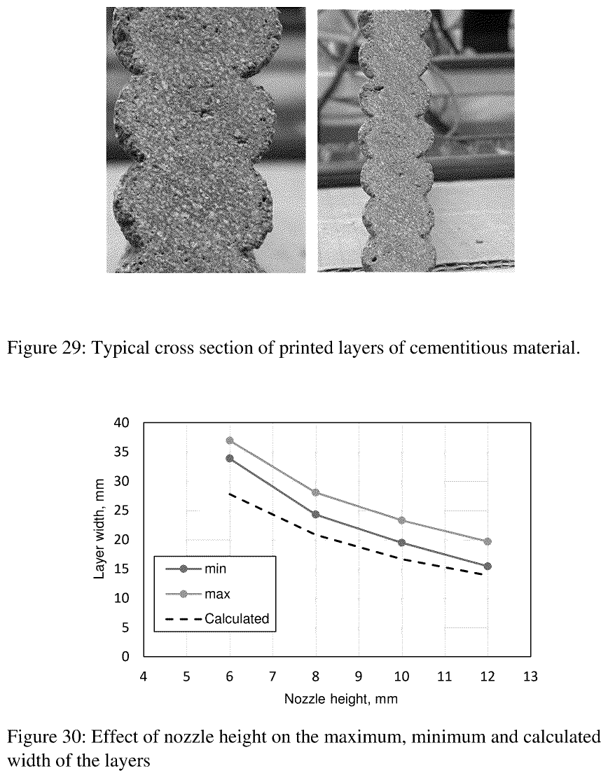

When referring to the technology, as outlined in the last paragraph of the previous section, there is also a need to address parameters which affect the shape and uniformity of the printed layers. This was attempted in this study by investigating the effect of the height of the nozzle and its printing velocity on the height and width of the printed layers. This phase of the study was carried out with the cementitious matrix and the geometry of the layers was studied after hardening, measuring the height of the layers and in particular the width, in its minimum location, at the interface between layers, and its maximum, in between, as seen in a typical cross section, FIG. 29. The velocities and height were kept in a range which provided coherent layers without observed defects.

Study of such effects is of practical significance when considering the accuracy required of the printed components, especially if they are expected to be assembled on site.

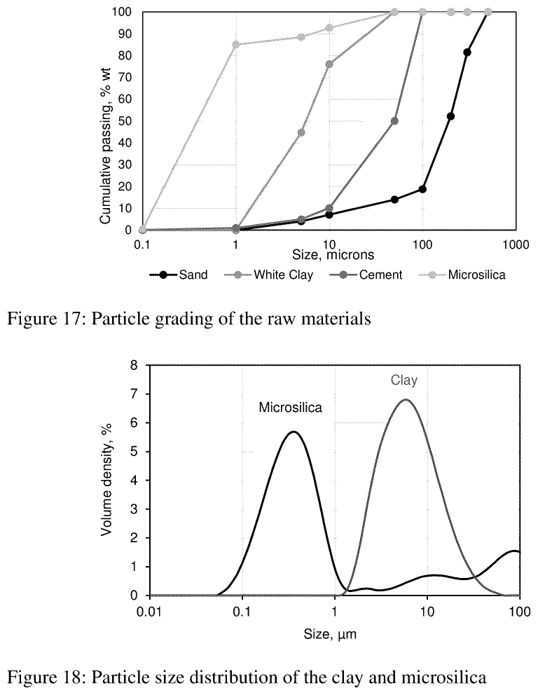

The influences of the height of the nozzle and the printing velocity are presented in FIGS. 17 and 18. The figures include also the calculated width of the layer, based on the following relation: (2) w=Q/(v*h), where Q—flow rate of the mix through the nozzle, v—velocity of the robot, i.e. of the nozzle at the printing head, and h—the height of the nozzle above the printing surface.

In these tests the flow rate, Q, was kept constant, at 1 liter/minute. The nozzle had a circular diameter of 12 mm. In the case of the test evaluating the effect of the nozzle height, the velocity of the nozzle was kept constant at 0.1 meter/second, while in the test evaluating the effect of the velocity of the nozzle the height was kept constant at 10 mm.

Equation (2) is a simplified one, as it includes implied assumptions, that the actual layer thickness is equal to the nozzle height and that the cross section is uniform. In practice both assumptions are not met: measurements of the height of the printed layers for the 6 mm nozzle height indicated that it is 5.5 mm on the average with 10% coefficient of variation, while the cross section of the printed layers is not uniform but tends to be elliptical in nature (FIG. 29).

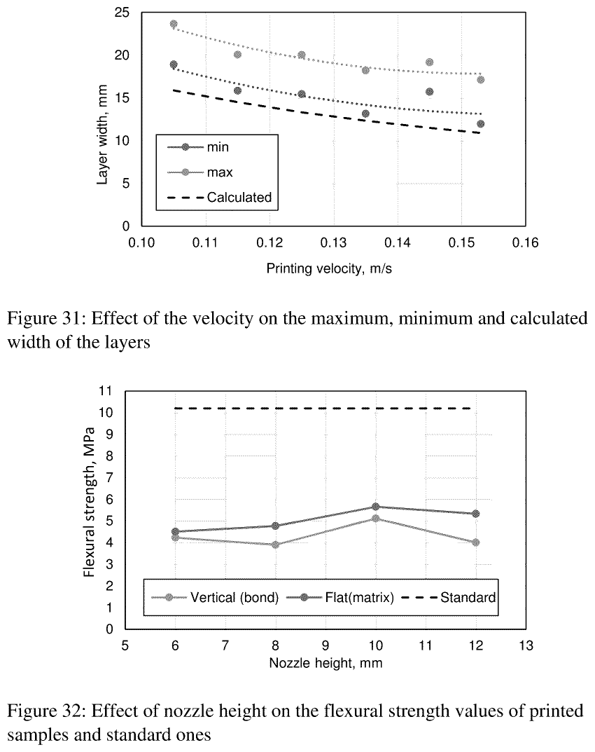

The trends indicate reduction in the width increase in the nozzle height (FIG. 30) and velocity (FIG. 31). In all cases, the actual width, the maximum as well as the minimum, where bigger than the calculated ones.

The following conclusions can be drawn with regards to the influences of the printing parameters, nozzle height, diameter, and velocity on the geometry of the printed layers:

The reduction of the width, maximum and minimum, with increase in nozzle height and velocity can be predicted by equation 2. However, the equation underestimates the width values, both minimum and maximum, which can be explained to be the result of the simplifying assumptions made by this relation.

There is a need to consider the viscoelastic properties of the material, which can be compressed during the discharge from the nozzle towards the underlying substrate. This compression is expected to be dependent on the ratio between the nozzle height and diameter: it will be reduced as this ratio increases.

When considering the above explanation, it should be noted that the compression during the printing is expected to have positive effects, including compaction of the mix which is thixotropic in nature and may have difficulty in effective consolidation under its own weight, as well generating improved bond between the layers. Thus, increasing the height to nozzle diameter ratio may have dual influences: improving the uniformity of the printed layers and reducing the compaction effect during the deposition of the printed layers which may result in compromising their strength. The latter is expected to be of a particular concern when the ratio approaches 1 and increases above it.

### Printing Process Parameters and Control of Mechanical Properties

The results and discussion in the previous sections suggested that the printing parameters may have influence on the compaction of the printed layers, and this implies also influences on their mechanical properties. Special compressing effect was predicted to occur due to changes in the height of the nozzle (or the ratio of nozzle height to diameter). Such influences were studied for the cementitious system after 28 days of hardening, based on the tests outlined above. Two parameters were evaluated:
(a) The change in the nozzle height, in the range of 6 to 12 mm, while keeping the nozzle diameter constant, at 12 mm, implying change in the nozzle height to ratio in the range of 0.5 to 1.0.
(b) The effect of the velocity was studied for a system with nozzle height of 10 mm and diameter of 12 mm, namely ratio of 0.83, where the compaction during printing might be less effective.

In the interpretation of these tests, the mechanical properties of the printed layers were compared with specimens produced from the same mix by standard tests, where standard laboratory compaction and curing was applied. The properties of this standard sample was 50.2 MPa and 10.0 MPa in compression and flexure, respectively.

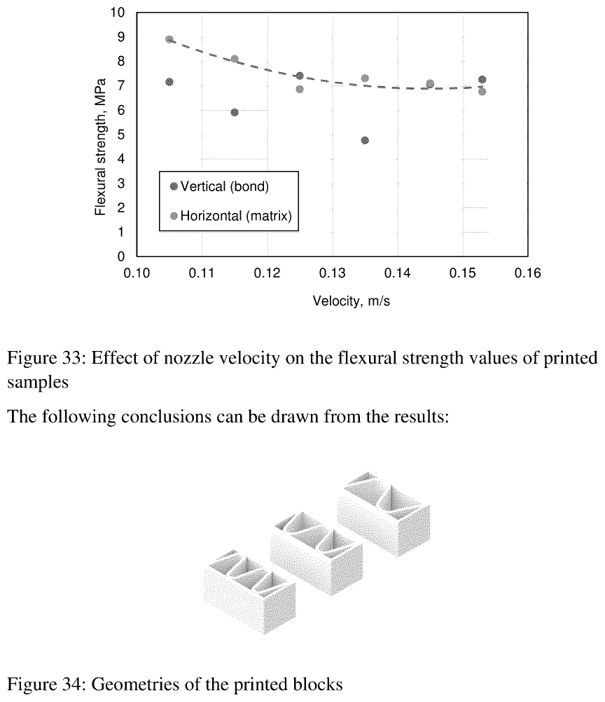

Results of the effect of nozzle height are presented in FIGS. 19, and for nozzle velocity in FIG. 33. The figures also include data on standard cast specimens. The tests of the printed samples were carried out in two directions, one which reflects sensitivity to the bond between layers and one where the bond has no influence, and the results reflect the properties of the matrix material in the layers.

The following conclusions can be drawn from the results:

In the range of parameters studied here, there was no significant influence of nozzle height and velocity on the mechanical properties, matrix strength as well as bond.

The values in the direction sensitive to bond were slightly lower than those reflecting the printed properties of the matrix, ranging from 75% to 100%, with no clear trend observed for the effect of nozzle height or velocity. This is indicative of a good bond formed between the layers, which is consistent with the observations of the cross-section, FIG. 29.

The values of the printed material seem to be consistently lower than that of the specimen which was produced by standard compaction and curing; the values seemed to range from 40 to 50% of the standard value. This implies that the printed mix does not achieve the full-strength potential of the material. Yet, the values achieved are sufficiently high, being about 5 MPa in flexure. This is about 10% of the compressive strength of the standard material which was 50.2 MPa. This difference might be explained by several influences: (a) the standard specimens were cured in water while the printed sample were kept in the laboratory air. (b) The compaction during printing is less efficient than the standard one, which involves mechanical compaction, whereas the printed material is less prone for self-compaction because of its thixotropic nature.

### Feasibility of Producing Optimized Building Components

### Blocks

The object of this part of the study was to explore the feasibility of using 3D printing to develop building components which will enable significant savings in construction materials. For that purpose, the component chosen was blocks of 200×200×400 mm, which are standard building components and are on the one hand sufficiently small to be evaluated on a laboratory scale, but at the same time relevant to be compared with commercial product, i.e., concrete block.

The geometries of the printed blocks are shown in FIG. 34, consisting of 3, 4 and 5 ribs. They were printed with the cementitious mix composition outlined in Table 2, and the velocity and nozzle height were varied in the range outlined in section 4.4, to achieve wall thickness in the range of 15 to 30 mm. In this range of printing the data indicates that the hardened properties are independent of the printing parameters and the bonding between the layers is of a quality similar to that of the matrix.

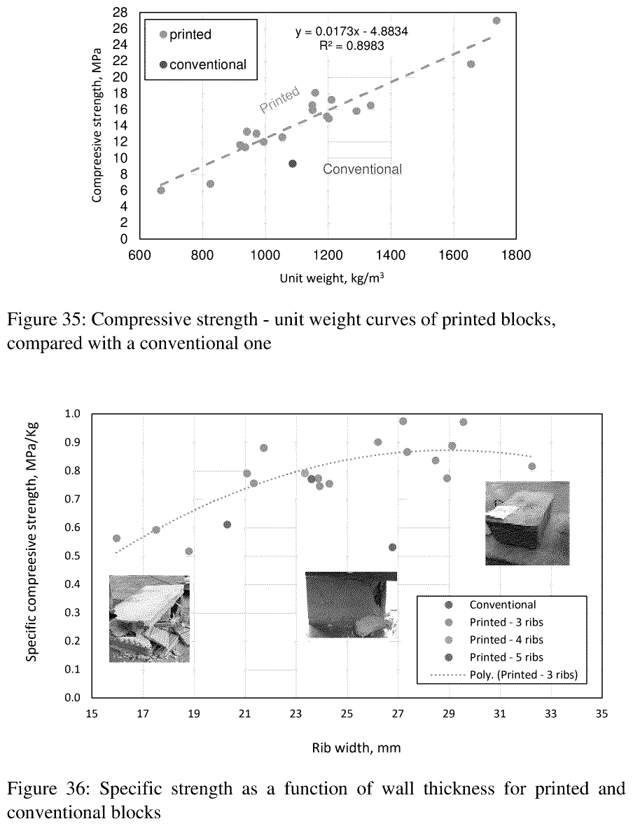

Data of the compressive strength of the blocks versus their unit weight is plotted in FIG. 35, which also includes a commercial block for comparison. It can be seen that for the same unit weight, the printed block is about 50% stronger than the conventional one. It should be noted that at a unit weight of 1700 kg/m³, the printed block achieves a compressive strength value of about 25 MPa, which is already in the range of structural concrete.

To better resolve the parameters influencing the strength obtained with the printed blocks, the values of specific strength (strength/weight) were plotted against the rib wall thickness, FIG. 36. The figure includes data highlighting the number of ribs and characteristic photos of the mode of failure.

The main conclusions to be drawn from FIGS. 22 and 23:

For a similar unit weight, the strength of the printed block is about 50% stronger than the conventional block.

The specific strength of the printed blocks seems to grow with the wall thickness in the range of 15 to 21 mm, and after that, they tend to remain practically constant. This change might be related to the mode of failure shown in the photos in FIG. 36, with the smaller wall thickness failure seem to be occurring by buckling while in the thicker wall it is by crushing. This may account for the smaller specific strength in the thin wall blocks. This suggests that there is room for improvement and optimization by controlling the geometry. Change in the number of ribs does not seem to provide an advantage.

The specific strength of the printed blocks, even those with the smaller values (thinner wall), are significantly higher than that of the conventional block. Construction elements

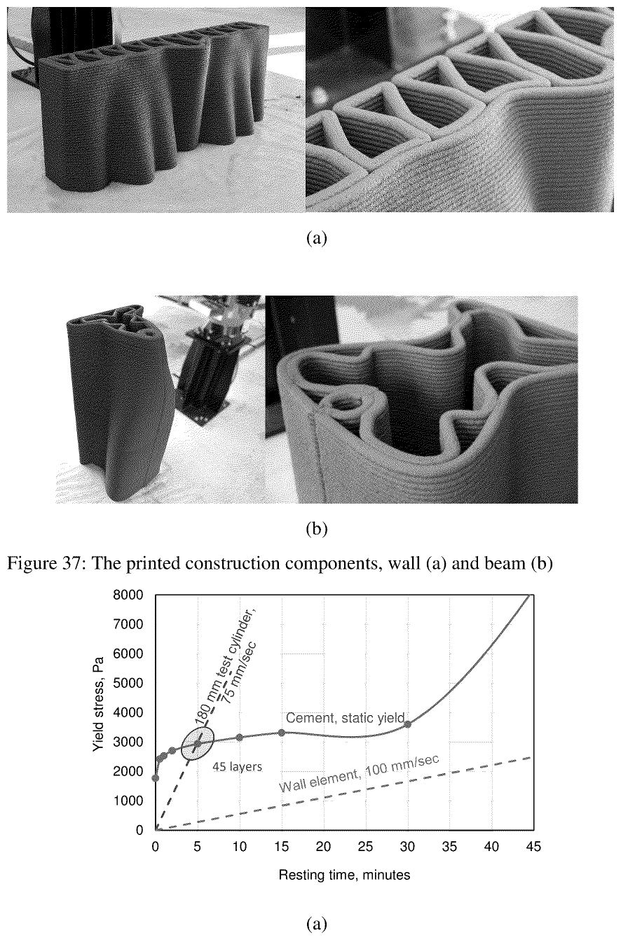

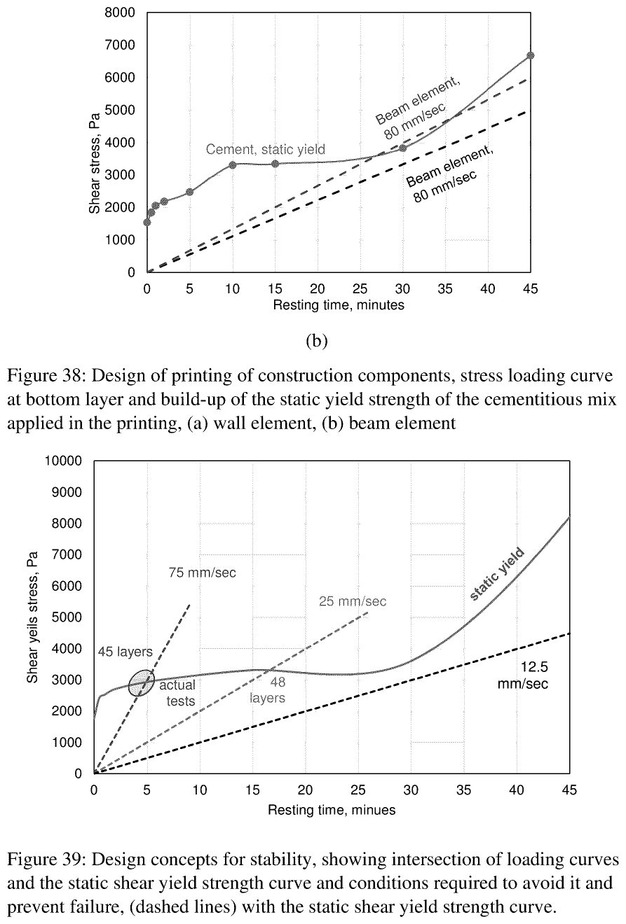

The printing technology design method and the cementitious mix developed were employed to demonstrate the feasibility for printing full scale construction components, wall, and beam elements [Mogra et al 2023], FIG. 37. These components were designed to achieve optimal mechanical and physical performance with the freedom to be of complex geometrical shape, assuming that it could be readily printed. The task presented here was to demonstrate how the deign principles outlined here could be employed for this purpose, and on that basis prove the feasibility by actually printing the components. For that purpose, the parameters for the printing process were designed to assure that the curve of loading is kept below the curve of the build-up of the static shear yield strength of the green material, while the dynamic yield strength is kept low and constant over the whole printing time of the element, which could be as long as 70 minutes. The outcome of the design load curve and the static shear yield strength for the two components are shown in FIG. 38. The beam element was designed to be 3 meter long, made of two halves which are assembled together by prestressing, which also serves for the reinforcement in the tension zone.

The printing data for the wall element are as follows:
Printing velocity—100 mm/sec
Average time for a single layer printing (average since they differ one from another)—80 sec
Total time for printing the whole element—4180 sec, 70 minutes
Number of layers—50
Nozzle height—10 mm
Nozzle diameter—12.5 mm
Width of layer—about 25 mm
The printing data for the beam element:
Nozzle diameter—12.5 mm
Printing velocity—0.08 m/s
Height of printed half section—1.5 m

### Conclusions

The main insights developed in this study cover a range of issues which are relevant to facilitate design procedures as well as overall optimization:

Basic rheological parameters can be employed to predict performance and thus provide the design principles for stability in printing in the green state.

These design principles can serve for an overall optimization guidance at the green state, to harmonize the printing parameters, materials properties, and component geometry.

The design principles formulated in this study can serve as a basis for a new approach for the printing stage, to enable the build-up of the layers and maintaining their stability without the need to resort to fast setting formulations; this approach can facilitate a more flexible manufacturing process, which is less sensitive to early setting of the materials in the production equipment. Obviously, this approach needs to be evaluated against the speed of printing to achieve optimization.

Performance parameters can be used for identifying the window of optimal material behavior to serve as a guide for engineering the materials' composition.

The concepts of the materials design enables to employ very fine sized raw materials, providing the potential for incorporating by-products.

Testing of small building components demonstrated the feasibility for considerable materials savings.

These insights can serve as a basis for design concepts of a system which combines Materials behavior in the green state, Production parameters (robot velocity and more), and components' geometry.

Thus, to achieve successful printing of large components (e.g., 3 meters), the design can be based on reducing the printing velocity (black dashed line, FIG. 39), or changing the composition to accelerate the rise in the static yield strength, without the need to reduce the printing speed (FIG. 40).

There is provided an integrative approach that is focused on an investigating of a range of granular materials and employing design procedures based on concepts developed by Kruger to demonstrate the feasibility to develop relations between material properties, printing technology and type of component printed to achieve optimization at different levels.

Particular emphasis is given to demonstrating the achievement of optimization with regards to materials saving, which is of relevance to environmental impact issues. An overall analysis of labor and materials costs in conventional construction shows that about 50% goes into formwork materials and labor and additional 25% to construction materials. The 3D printing can have the potential to reduce dramatically the 50% of formwork and additional 50% of the construction materials, mainly concrete. The materials savings has an environmental impact which is perhaps much more significant than the cost savings, as implied in the bleak future of dramatic reduction in availability of raw materials for concrete, due to ecological constraints, which are associated with limitations on quarries and carbon foot-print of cement production.

There is a pressing need for an integrated method that synergizes material composition, architectural design, and manufacturing processes in 3D printing. Such a method would not only streamline the construction process but also significantly reduce material waste, labor requirements, and overall project timelines. The integration of these aspects is crucial for advancing the practicality and sustainability of 3D printing in architectural construction.

The suggested solution introduces an innovative method for the design and 3D printing of multifunctional architectural and structural components, integrating material composition, architectural design, and manufacturing parameters into a cohesive process.

According to an embodiment, the method applies a holistic approach: simultaneously optimizing the material composition, architectural design, structural design, and manufacturing parameters to achieve a seamless and efficient 3D printing process. This approach ensures that each component is not only structurally sound and aesthetically pleasing but also tailored to specific functional requirements. The method represents a significant advancement in the field of architectural design and construction, enabling the production of customized, multifunctional components in one go.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that can be executed by the system and should be applied mutatis mutandis to a non-transitory computer readable medium that stores instructions that once executed by a computer result in the execution of the method.

This application provides a significant technical improvement over the prior art-especially an improvement in computer science.

Any reference to the term “comprising” or “having” should be interpreted also as referring to “consisting” of “essentially consisting of.” For example-a method that comprises certain steps can include additional steps, can be limited to the certain steps, or may include additional steps that do not materially affect the basic and novel characteristics of the method-respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product such as non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input and responds by allocating and managing tasks and internal system resources as a service to users and programs of the system. The computer system may for instance include at least one processing unit, associated memory, and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks, circuit elements, or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also, for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for providing an architectural component, the method comprises:
receiving, by a computerized system, a request to design a manufacturing process of an architectural component;
determining, by the computerized process, the manufacturing process by applying an interactive design process that considers interactions between (a) material composition parameters, (b) architectural design parameters, and (c) manufacturing parameters; wherein the manufacturing process is an additive three-dimensional printing process; and
applying the manufacturing process by a three-dimensional printer to provide the architectural component.

2. The method according to claim 1, comprising storing manufacturing process information regarding the manufacturing process in a file that is access controlled; and applying an access control scheme for allowing access only to authorized three-dimensional printer while preventing authorized three-dimensional printers from accessing the file and applying the manufacturing process.

3. The method according to claim 1, comprising determining a cementitious mix that is tailored for the additive three-dimensional printing process.

4. The method according to claim 3, wherein the determining of the cementitious mix comprises determining a composition of the cementitious mix by incorporating a variety of mineralogical additives/fillers and chemical admixtures along with cement and graded siliceous sand.

5. The method according to claim 3, wherein the determining of the cementitious mix comprises simulating different candidate compositions of the cementitious mix.

6. The method according to claim 3, wherein the determining of the cementitious mix comprises determining a window of optimization of properties of the cementitious mix.

7. The method according to claim 6, further comprising selecting the cementitious mix based on particle size distributions of different candidate compositions of the cementitious mix within the window.

8. The method according to claim 3, wherein the determining of the cementitious mix comprises determining the rheological properties of the cementitious mix.

9. The method according to claim 8, wherein the rheological properties of the cementitious mix are evaluated based on manufacturing parameters related to the additive three-dimensional printing process.

10. The method according to claim 8, wherein the determining of the cementitious mix is based on (a) required dynamic yield strength throughout the additive three-dimensional printing process, and (b) a required static yield strength rapidly increase once the cementitious mix is deposited as a layer during the additive three-dimensional printing process.

11. The method according to claim 3, comprising determining a static and dynamic yield strength of the cementitious mix.

12. The method according to claim 3, wherein the determining comprises modelling a stability, within a defined period of time at an absence of dedicated curing process, of a layer of the cementitious mix that was printed during the additive three-dimensional printing process.

13. The method according to claim 3, wherein the determining comprises maintaining a stress build-up on any layer of the cementitious mix of the architectural component is below a static yield strength of the layer.

14. The method according to claim 3, wherein the determining is responsive to an inflection point of the cementitious mix.

15. The method according to claim 14, wherein at least one manufacturing parameter is determined based on the inflection point.

16. The method according to claim 15, wherein the at least one manufacturing parameter is a printing rate.

17. The method according to claim 3, wherein the determining comprises iteratively adjusting the printing parameters and material composition parameters of the cementitious mix over time.

18. The method according to claim 1, comprising determining one or more architectural design parameters following a finding of one or more cementitious mix candidates that once printed provide a layer of at least a required stability.

19. The method according to claim 1, comprising determining one or more architectural design parameters, wherein the determining one or more architectural design parameters comprises defining a shape and an internal structure of the architectural component.

20. The method according to claim 19, wherein the defining of the shape and of the internal structure ensures mechanical stability of the architectural component.

21. The method according to claim 20, wherein the defining of the shape and of the internal structure further minimizes a usage of a cementitious mix during the additive three-dimensional printing process.

22. The method according to claim 1, wherein the determining is responsive to requested multiple functionalities of the architectural component.

23. The method according to claim 1, wherein the determining is responsive to a passage of utility conduits through the architectural component.

24. The method according to claim 1, wherein the determining is responsive to a thermal performance of the architectural component.

25. The method according to claim 1, wherein the determining comprises optimizing the interactions between (a), (b) and (c).

26. The method according to claim 1, wherein the determining comprises adjusting one or more rheological properties of a cementitious mix to meet manufacturing parameters.

27. The method according to claim 26, wherein the manufacturing parameters comprise at least one of printing speed and nozzle movement.

28. The method according to claim 26, wherein the rheological properties comprise a transition of a cementitious mix from a fluid state to a solid state.

29. The method according to claim 26, wherein the manufacturing parameters comprise overhang angles and overlap between layers of the cementitious mix.

30. An architectural component, comprising:
cementitious mix made components;
wherein the architectural component is manufactured by a method comprising:
receiving, by a computerized system, a request to design a manufacturing process of an architectural component;
determining, by the computerized process, the manufacturing process by applying an interactive design process that considers interactions between (a) material composition parameters, (b) architectural design parameters, and (c) manufacturing parameters; wherein the manufacturing process is an additive three-dimensional printing process; and
applying the manufacturing process by a three-dimensional printer to provide the architectural component.

31. A non-transitory computer readable medium for providing an architectural component, the non-transitory computer readable medium stores instructions that once executed by a system that comprises a processing circuit, causes the processing circuit to:
receive a request to design a manufacturing process for an architectural component;
design the manufacturing process by applying an interactive design process that considers interactions between (a) material composition parameters, (b) architectural design parameters, and (c) manufacturing parameters; wherein the manufacturing process is an additive three-dimensional printing process; and
controlling, by the processing circuit, an applying of the manufacturing process by sending over secure communication links, a three-dimensional printer to provide the architectural component.

32. A method for providing an architectural component, the method comprises:
receiving, by a computerized system, a request to design a manufacturing process of an architectural component;
determining, by the computerized process, the manufacturing process by applying an interactive design process that considers interactions between (a) material composition parameters, (b) architectural design parameters, and (c) manufacturing parameters; wherein the manufacturing process is an additive three-dimensional printing process; and
responding to the designed manufacturing process

33. A non-transitory computer readable medium for providing an architectural component, the non-transitory computer readable medium stores instructions that once executed by a system that comprises a processing circuit, causes the processing circuit to:
receive a request to design a manufacturing process for an architectural component;
design the manufacturing process by applying an interactive design process that considers interactions between (a) material composition parameters, (b) architectural design parameters, and (c) manufacturing parameters; wherein the manufacturing process is an additive three-dimensional printing process; and
respond to the designed manufacturing process.
